(19) United States
(12) Patent Application Publication
(10) Pub. No.: US 2010/0178934 A1
(43) Pub. Date: Jul. 15, 2010

(54) ENVIRONMENT-SPECIFIC MEASUREMENT WEIGHTING IN WIRELESS POSITIONING

(75) Inventors: Mark Leo Moeglein, Ashland, OR (US); Douglas Neal Rowitch, Del Mar, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/686,299

(22) Filed: Jan. 12, 2010

Related U.S. Application Data
(60) Provisional application No. 61/144,405, filed on Jan. 13, 2009.

(51) Int. Cl. H04W 24/00

(52) U.S. Cl. 455/456.1

(57) ABSTRACT

The subject matter disclosed herein relates to a system and method for estimating a location of a mobile station based, at least in part, on one or more measurements obtained from the mobile station based at least in part on one or more signals received by the mobile station from one or more signal sources. Such measurements may be combined based, at least in part, on estimates of measurement errors associated with the signal sources. In a particular implementation, such error estimates may be updated to account for changes in an operational environment.

### CROSS-REFERENCES TO RELATED APPLICATIONS

This application claims priority to provisional patent application Ser. No. 61/144,405, entitled “Environment-Specific Measurement Weighting in Wireless Positioning,” which was filed on Jan. 13, 2009, the disclosure of which is incorporated by reference in its entirety as if fully set forth herein.

### BACKGROUND

1. Field

The subject matter disclosed herein relates to a method of estimating a location of a mobile station.

2. Information

There is a variety of ways in which the geographical location of an electronic device, such as a mobile station, may be determined. A location of a mobile station may be estimated from Global Positioning System (GPS) pseudorange measurements obtained from a number of Satellite Vehicles (SVs), such as GPS satellites. In some alternative systems, such a location may be estimated from measurements derived via a terrestrial navigation system, such as an Advanced Forward Link Trilateration (AFLT) system. In an AFLT system, a mobile station may receive pilot signals from a number of base stations having known locations and a location of the mobile station may be determined based on the pilot signals received from such known base stations.

A location estimate for a mobile station may be determined based on measurements obtained from several sources, such as AFLT and GPS, among others, as discussed above. Each of the measurements may be associated with a respective error estimate. An error estimate associated with a particular measurement may be static, e.g., unchanging, regardless of current environmental conditions such as, for example, terrain, urban environment or current weather conditions. The error estimates may be utilized to determine a respective weighting to apply to each respective measurement. The location of the mobile station may be estimated based on a combination of the weighting of each respective measurement.

### BRIEF DESCRIPTION OF THE FIGURES

Non-limiting and non-exhaustive features will be described with reference to the following figures, wherein like reference numerals refer to like parts throughout the various figures.

FIG. 1 is a schematic block diagram of a navigation system according to one implementation.

FIG. 2 is a flow diagram illustrating a process for estimating a location of a mobile station according to one implementation.

FIG. 3 is a flow diagram illustrating a process of estimating a location of a mobile station according to one implementation.

FIG. 4 is a flow diagram illustrating a process of estimating a location of a mobile station according to one implementation.

FIG. 5 illustrates a measurement error model/map according to one particular implementation.

FIG. 6 is a flow diagram of a process for updating forward link calibration (FLC) measurements according to one implementation.

FIG. 7 is a flow diagram of a process for updating Maximum Antenna Range (MAR) values for error estimates according to one implementation.

FIG. 8 is a schematic diagram of a mobile station according to one implementation.

FIG. 9 is a diagram of a system for determining a location of a mobile station according to one implementation.

FIG. 10 illustrates a base station and a coverage area according to one implementation.

FIG. 11 is a flow diagram of a process for determining a location of a mobile station according to one implementation.

FIG. 12 illustrates aspects of a station according to one implementation.

FIG. 13 illustrates aspects of calibration timing error information stored in a base station almanac according to one implementation.

### SUMMARY

A method is provided for estimating a location of a mobile station. One or more measurements are obtained from a mobile station based at least in part on one or more signals received by the mobile station from one or more signal sources. Estimates of measurement errors associated with at least one of the one or more signal sources may be updated based, at least in part, on one or more, for example historical, measurements associated with the at least one of the signal sources. A location of the mobile station may then be estimated based, at least in part, on the one or more measurements and estimates of errors associated with the one or more measurements. Estimating a location of the mobile station may be performed within an asynchronous system, and may further comprise estimating a frame timing relationship of the asynchronous system and/or estimating a timing uncertainty of the asynchronous system. A size or a confidence interval for the size of at least one coverage area may be estimated. At least one pseudorange measurement to at least one of the one or more signal sources may be obtained. The estimates of the measurement errors may be updated with the at least one pseudorange measurement. Estimates of measurement errors may comprise measurements obtained over a predetermined time interval. The estimates of measurement errors and/or the historical measurements may be stored in at least one measurement error model/map. One or more forward link calibration values of the at least one measurement error model/map may be updated based at least in part on measurements associated with one or more location fixes for the mobile station. One or more Maximum Antenna Range (MAR) values of the at least one measurement error model/map may be updated based at least in part on measurements associated with one or more location fixes for the mobile station. A method is provided for communicating with a serving signal source providing wireless service to a mobile station within a serving sector and acquiring one or more calibration error estimates associated with the serving wireless network transmission element and one or more other signal sources, based at least in part on an identity of the serving signal source. The one or more calibration error estimates may be utilized to determine primary ranges from the mobile station to the serving signal source and at least two other signal sources. A location of the mobile station may be estimated based at least in part on the determined primary ranges. A velocity of the mobile station may be estimated based at least in part on the calibration error estimates, wherein the calibration error estimates comprise Doppler or delta-range bias or uncertainty information. One or more location-specific calibration error estimates associated with the estimated location of the mobile station may be acquired. The one or more location-specific calibration error estimates may be utilized to determine one or more secondary ranges from the mobile station to the serving signal source and at least two other signal sources. A location of the mobile station may be estimated based at least in part on the determined secondary ranges. An elevation associated with the estimated location may be estimated from a geographical model. The one or more calibration error estimates are based at least in part on a channel utilized by the serving signal source to provide wireless service to the mobile station. The one or more calibration error estimates may be acquired from a base station almanac. It should be understood, however, that other implementations may be employed without deviating from claimed subject matter.

### DETAILED DESCRIPTION

Reference throughout this specification to “one example”, “one feature”, “an example” or “a feature” means that a particular feature, structure, or characteristic described in connection with the feature and/or example is included in at least one feature and/or example of claimed subject matter. Thus, the appearances of the phrase “in one example”, “an example”, “in one feature” or “a feature” in various places throughout this specification are not necessarily all referring to the same feature and/or example. Furthermore, the particular features, structures, or characteristics may be combined in one or more examples and/or features.

Location determination and/or estimation techniques described herein may be used for various wireless communication networks such as a wireless wide area network (WWAN), a wireless local area network (WLAN), a wireless personal area network (WPAN), and so on. In this context, a “location” as referred to herein relates to information associated with a whereabouts of an object or thing according to a point of reference. Here, for example, such a location may be represented as geographic coordinates such as latitude and longitude for a particular mobile station. Alternatively, such a location may be represented as a street address, municipality or other governmental jurisdiction, postal zip code and/or the like. However, these are merely examples of how a location for a mobile station may be represented according to particular embodiments and claimed subject matter is not limited in these respects.

There may be multiple sources of measurements used in estimating a location of, for example, a mobile station. In one implementation, an Advanced Forward Link Trilateration (AFLT) system utilizing various base stations may provide such measurements. There may be additional sources, which may provide Satellite Positioning System (SPS) measurements. Here multiple measurements from one or more sources may be weighted and/or combined based, at least in part, on estimates of errors associated with such measurements using techniques known to those of ordinary skill in the art.

In one example implementation, a navigation system may employ static error estimates associated with measurements from any particular signal or measurement source. For example, a measurement from an AFLT system may be associated with a static, e.g., fixed, error estimate. The same error estimate may be utilized regardless of spatial or temporal variation in environmental conditions that may, in fact, affect the accuracy of such measurements. By utilizing a static error estimate without accounting for varying conditions, a resulting location estimate may be skewed by, for example, overweighting measurements from sources where an error estimate under-represents errors from such sources. Likewise, without accounting for changing environmental conditions, a resulting location estimate may be skewed by, for example, underweighting measurements from sources where an error estimate over-represents errors from such sources. Changes in environmental conditions may be with respect to temporal or spatial concerns and/or with respect to a given beacon or set of beacons. For example, an improved estimate for a location of a mobile station may be found as the intersection of coverage areas of a plurality of transmitters it can receive. Such transmitters may be configured to be broadcast-only transmitters, such as those for television or radio, or they may be configured for two-way communications transceivers such as two-way wireless base stations, Wi-Fi access points, femtocells, and etc., for example.

In one particular implementation, as discussed below, error estimates for various measurements may be periodically updated to reflect changing environmental conditions that may affect a change in accuracy of measurements from any particular source. By periodically updating such error estimates, as opposed to utilizing static error estimates regardless of current conditions, more accurate location estimates for a mobile station may be determined.

In another implementation, a static, or slowly changing, map of errors associated with a given coverage area may be assembled from errors observed by a mobile station. This map may be as simple as basic statistics about the errors observed in a given sector, or it may be more complex, containing a model for errors as a function of location, relative or absolute signal strength, distance from the transmitter, etc. There may be generally two fundamental types of measurements for which errors may be determined.

The first type, a more coarse but readily available type of measurement, is a simple transmitter identifier, and may be accompanied by a signal strength. Such an identifier can be associated with a transmitter coverage area, thus establishing an area in which a mobile station is likely to be located. However, a size of a coverage area for any given transmitter may vary substantially, depending upon transmitting and receiving antenna patterns, blockage, and many complex factors that may be difficult to model. It may therefore be important to learn statistical representations of a transmitter coverage area over time, to minimize errors associated with such coverage areas and maximize location accuracy. Such a learning process may typically be handled by parametric means, fitting observed mobile locations to a model based upon typical coverage areas for that transmitter type, but modifying such a model based upon observed deviations from the typical statistics. One implementation of such a self-learning model may utilize sign test filters to keep track of coverage area sizes at one or more percentile values. Another may keep track of standard deviations or similar measures of statistical spread. As more data points are entered into such a model for each coverage area, a magnitude or shape of a modeled coverage area may increase or decrease. However, uncertainty associated with the coverage area size may typically decrease.

The second, and typically more precise, type of measurement is a pseudorange estimate from a transmitter with a highly stable frequency source and a well-established repeating signal pattern that can be detected to establish a pseudorange estimate. In many cases, timing of the signal may be unknown, but repeatable and slowly varying over time due to a highly accurate frequency source. In such cases, it may be useful to observe timing errors. It may also be useful to observe characteristics of timing errors, such as change rate, spread characteristics and any other associated reliability information. Filters similar in nature to those described for detecting and modeling coverage areas can be used to detect and model timing offsets, change rates, error biases and spreads. However, different types of errors may be likely to fit better to different statistical distributions, and so it should be appreciated that filters for different transmitter types may start with different assumptions for distribution type and size.

It should be appreciated that such errors may be calculated by the mobile station itself or by a network entity such as a Location Server, Position Determination Entity (PDE), Serving Mobile Location Center (SMLC) or other entity with a capability to calculate a location of a mobile station. Furthermore, some filtering may be performed at such a mobile station before forwarding intermediate parameters to a network entity. Such a network entity may accept such filtered values implicitly or include them into its own model with appropriate weights. Such weights for inclusion may be based upon a historical accuracy of data provided by similar types of devices and/or transmitter types. For example, some devices may be more sensitive than others. This implies that they will observe greater coverage area sizes and, because they are able to observe weaker, more indirect, signals, their ranging errors are likely to be higher as received signal strength declines.

It should be appreciated that in dense urban environments, a coverage area of certain transmitter types is likely to be smaller, leading to more accurate coverage area based inputs to a navigation filter. In such environments, errors associated with ranging signals may tend to be higher, as well. However, the opposite may be true in a typical rural environment. Thus, it may be important to observe actual errors and coverage area sizes and make such information available to an entity that is calculating a location of a mobile station.

In a further implementation, error model information may be used to determine a method to be used in determining a location fix. For example, in some urban environments, coverage area information may be sufficient to determine a street upon which a user is located. However, in other environments, ranging information may be required. Furthermore, in some environments, it may be easy to capture coverage area signals, whereas in other environments, certain types of ranging signals may be readily available. Thus, accuracy and availability of each potential measurement may be useful if known by such a mobile station, so that appropriate prioritization decisions can be made.

Although a specific implementation of a sign test filter for tracking range errors is discussed herein, it should be appreciated that a vast array of techniques may be employed with a similar effect.

According to a particular example, a device and/or system may estimate a location of a particular mobile station based, at least in part, on signals received at the mobile station from base stations, satellite vehicles (SVs) such as geostationary satellites, for example, and/or other measurement sources. In particular, such a location may be estimated based, at least in part, on “pseudorange” measurements, to such SVs. In a particular example, such a pseudorange may be determined at a receiver that is capable of processing signals from one or more SVs as part of a Satellite Positioning System (SPS). To estimate its location, a receiver and/or mobile station may obtain pseudorange measurements to three or more SVs. Measurements from pilot signals received from base stations may also be utilized to determine a location of such a receiver and/or mobile station.

A mobile station may obtain measurements from signals received from various sources. Such measurements may be used to estimate a location of such a mobile station. For example, in an AFLT system, pilot signals may be received from a number of base stations having known locations. A location of such a mobile station may be determined based on measurements from such pilot signals received from such known base stations. Such measurements may include time/distance readings from respective base stations transmitting such pilot signals. Such time/distance readings may be used to derive pseudorange measurements to the mobile station receiving the pilot signal. Additional and/or alternative measurement sources may be associated with SVs in an SPS in, for example, a hybrid approach to estimating a location of a mobile station. In particular embodiments, measurement sources may include one or more transmitters for transmitting measurements via, for example, one or more signals.

There may, however, be a certain degree of uncertainty associated with such measurements discussed above. For example, in certain terrains, such as a valley, or in certain weather conditions or at certain times of the day, the amount of uncertainly associated with a particular measurement may vary. Such a degree of uncertainty may be expressed as an error estimate for a particular measurement. An error estimate may be quantified as, for example, a fixed value in a given set of units (such as units of time or distance) at a specified confidence level or number of standard deviations, all meant to imply that the error will be less than an associated value a certain percentage of the time. Error estimates may also be represented as a function of the location of the mobile station and/or as a function of parameters such as received signal strength. Error estimates may also be taken from a terrain elevation model that determines whether a mobile station is likely to have a very indirect signal path or a direct line of sight to a given beacon (e.g., SPS, a terrestrial transmitter such as a CDMA2000 base station, and etc.).

As pointed out above, error estimates may be utilized in assigning weights to measurements in estimating a location for a particular mobile station. A larger weighting may be assigned to a measurement associated with a small error estimate, and a smaller weighting may be assigned to a measurement associated with a large error estimate. If one or more of such error estimates is erroneously large or small, an overall determination of a location of such an associated mobile station may be less accurate. For example, use of such erroneous error estimates may result in, for example, a determination of a location that is many meters away from such an associated mobile station's actual location.

In a particular implementation discussed below, a feedback process may update error estimates associated with measurements sources such as base stations, SVs in an SPS, and/or the like, instead of relying on static a priori error estimates (e.g., fixed values or values based upon parameters associated with the measurements such as signal to noise ratio or signal strength) that have previously been assigned to particular beacons. In one implementation, a measurement error model/map may be stored in a memory device accessible by either, or both, of a mobile station and a location server, to name one example. Such a measurement error model/map may associate measurement error estimates with certain measurement sources, such as base stations and SVs, just to name a few examples. Such measurement error estimates may differ based on an operating environment in which such a mobile station is likely located. For example, in some areas, the further away that the mobile station is located from a particular beacon, the larger such an error estimate may be than it would be if such a mobile station were located closer to such a beacon. However, in other areas, this dependence upon distance to the beacon may not be observable. Similarly, in some areas, SPS errors may depend largely on signal strength and/or elevation angle, whereas in others, the errors may not be so large.

In a particular implementation discussed below, a location of a mobile station may be estimated from pseudorange measurements to one or more SVs in an SPS. Again, such estimate may also be determined, at least in part, from measurements obtained from one or more base stations of an AFLT system. In one implementation, based on such a location estimated using pseudorange measurements to SVs in an SPS, error estimates associated with base stations in an AFLT system may be updated. Here, such a location estimate may be compared with measurements associated with base stations. Accordingly, measurements associated with certain base stations may be updated based on such comparisons. In one particular implementation, a measurement error model/map may associate measurement errors with particular measurement sources (e.g., base stations, SVs in an SPS). In the event that, for example, navigation signals are received from more sources than a minimum required to determine the position of the mobile station, the additional information may be utilized to estimate the error on each individual measurement, in the form of a residual. Such residual errors may be provided to an error model for each transmitter and/or signal type. Such an improved error model may then be used to provide an a priori error estimate for measurements taken subsequently, and therefore improve the accuracy of the position estimate and also its associated a posteriori (e.g., after a position fix) position error estimate.

In one implementation, a process and system may be utilized to provide a mobile station with accurate error estimates based on an estimate of the mobile station's current location. A mobile station may receive pilot signals from various base stations when initially powered on, on an on-going basis, or in the event that the mobile station attempts to determine its current location. In one implementation, a mobile station may communicate with and receive wireless service from a base station providing, for example, a strong signal. A base station may provide wireless service to a certain coverage area. Such a coverage area may comprise multiple sectors. For example, a particular base station may provide wireless service to three sectors within a coverage area. In some implementations, a base station may provide wireless service to more or fewer than three sectors within a given coverage area. In one implementation, a base station may provide wireless service via different channels within a particular sector. For example, a base station may provide wireless service via three different frequencies, spreading codes, or time slots for each sector. Such frequencies, codes, and/or time slots may form logical channels with independent error modeling. A degree of correlation on spatially related sectors may be observed, tracked and used.

In one implementation, an error estimate associated with a channel of a base station providing wireless service to a mobile station may be retrieved from a base station almanac (BSA) and utilized to estimate the uncertainty of a range from the base station to the mobile station. For example, such an error estimate may include an estimated timing error. Such an error estimate may include both a median or median timing error and a spread of timing errors. A spread of timing errors may refer to a standard deviation, or a difference between two percentiles, for example. Such error estimates may be retrieved from a base station almanac. In one implementation, a mobile station may download or otherwise be provided with one or more files containing error estimates associated with a particular base station. For example, a base station may provide an identifier to a mobile station via a transmitted signal and the mobile station may transmit a message to a predefined address, or to an address specified by a base station, requesting timing error models for the base station associated with the identifier.

In one implementation, one or more error estimates associated with wireless service provided by a base station may be utilized to determine a weight for a range measurement taken by a mobile station. A potential drawback, however, of utilizing a signal error estimate is that actual timing errors may vary throughout a coverage area for a base station. A more accurate error estimate may be obtained by determining a serving sector that is providing wireless service to a mobile station. For example, in the event that a base station provides wireless service via three different sectors, for example, different error estimates may be associated with each sector. Moreover, different error estimates may also be associated with different channels utilized for providing wireless service within each sector. Error estimates may also vary by position within a sector.

A “serving sector” as used herein may refer to a sector providing wireless service to a mobile station. In the event that a particular base station provides wireless service via multiple different sectors, a serving sector for a particular mobile station may refer to the actual sector providing such wireless service to the mobile station. Examples of wireless services include voice communication, data transmissions, location services, and Internet service, to name just a few among many different examples.

After a location of a mobile station has initially been determined based on triangulation, for example, location information associated with the mobile station may be further refined to determine a more precise location of the mobile station. For example, a base station almanac may contain a mapping or grid indicating error estimates associated with particular geographical areas. For example, instead of utilizing a single error estimate associated with a serving sector, a position estimate may be iteratively refined as the position and uncertainty become better known. For example, there may potentially be hundreds of different error estimates associated with various locations of a serving sector. Moreover, there may also be different error estimates associated with other base stations based on an initial location of the mobile station. After signal information is processed using such focused error estimate information, a more precise location of a mobile station may be determined. Appropriate care may be taken with such iterative approaches to avoid instability and/or non-converging solutions. Convergence strategies may include, for example, limiting step sizes and cutting off iterations after a certain number has been reached.

Other factors affecting an error estimate may include geographical elevation or terrain of particular areas with a coverage area for a base station. Topographical information may be used to determine when line-of-sight conditions may exist between a mobile station and a base station antenna.

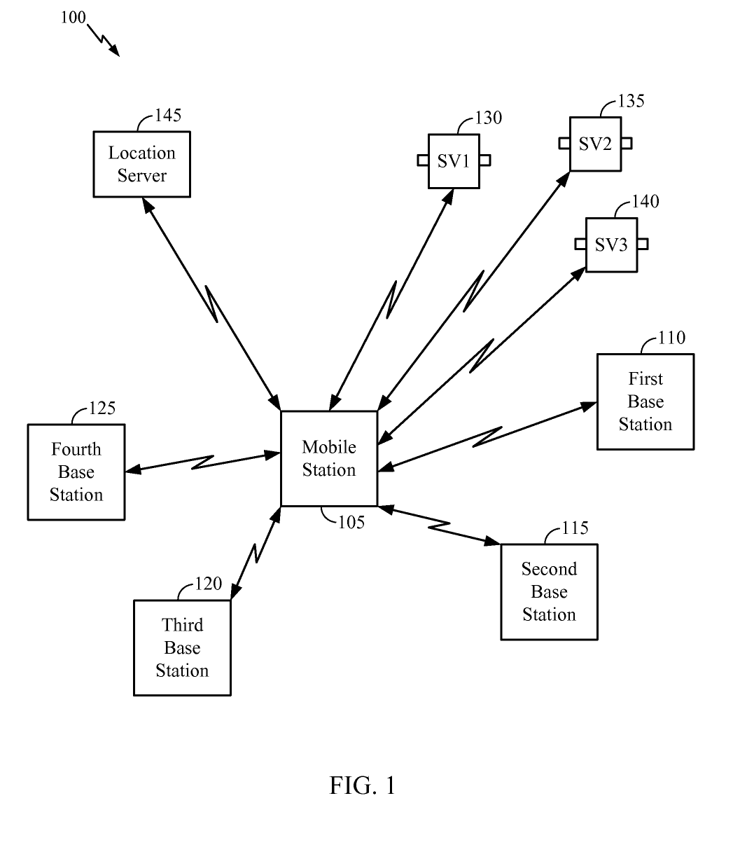

FIG. 1 is a schematic block diagram of a navigation system 100 according to one implementation. In this example, a mobile station 105 communicates with both a ground-based navigation system, such as an AFLT system, and a satellite-based navigation system, such as a GPS system. Such an AFLT system may include a first base station 110, a second base station 115, a third base station 120, and a fourth base station 125. Such a GPS system may comprise one or more SVs, such as SV1 130, SV2 135, and SV3 140. Such a navigation system 100 may also include a location server 145 for estimating a location of mobile station 105 based on measurements provided by mobile station 105.

In one particular implementation, location server 145 may maintain a measurement error model/map in which estimated measurement errors for various measurement sources (such as, for example, base stations of such an AFLT system) may be maintained. Such a measurement error model/map may be determined based on a history of measurements. An error model/map may start with an initial distribution, assumed for a given beacon type and modeled parameter. Such an initial distribution may also be learned from nearby beacons with similar characteristics. A modeled error distribution may be updated after receipt of each new error estimate from such a mobile station. Such a measurement error model/map may be stored in a memory device (not shown) located within such a location server 145, or accessible to such a location server 145. Such a measurement error model/map may also include a history of measurement errors corresponding to one or more measurement sources, such as, for example, base stations of an AFLT system. Mobile station 105 may obtain measurements from nearby base stations of such an AFLT system and provide them to location server 145. Location server 145 may, in turn, determine weightings for each received measurement based on various factors such as signal strength corresponding to a pilot signal transmitted from a particular base station and an error estimate associated with such a measurement. Other factors may additionally be considered in determining an appropriate weighting for a measurement from a base station.

In one implementation, mobile station 105 may also obtain pseudorange measurements from an SPS system including, in one implementation, SV1 130, SV2 135, and SV3 140. Upon receipt of such pseudorange measurements, mobile station 105 may provide such information to location server 145.

Location server 145 may process measurements from one or more measurements sources, for example, including either, or both, of an AFLT system comprising various base stations and an SPS system comprising, for example, SVs to estimate a location of mobile station 105. In the event that, for example, mobile station 105 is unable to obtain sufficiently accurate pseudorange measurements from the SPS to estimate a location of mobile station 105, location server 145 may estimate a location of mobile station 105 based primarily, or exclusively, on measurements from such an AFLT system comprising various base stations.

In particular implementations, pseudorange measurements obtained from acquisition of an SPS alone may provide a more accurate estimate of a location of a mobile station than would AFLT measurements (e.g., from acquisition of a terrestrial pilot signal). In a particular instance where both SPS measurements and AFLT measurements are available, location server 145 may determine a location of mobile station 105 based primarily, or exclusively, on such SPS pseudorange measurements. However, location server 145 may also use SPS pseudorange measurements to update estimates of errors associated with AFLT measurements obtained from acquisition of pilot signals transmitted by particular base stations. Here, for example, location server 145 may estimate a location of a mobile station based upon SPS measurements. AFLT measurements derived from particular base stations may then be compared to the location estimate to provide residual values that may be used in updating error models associated with measurements taken from the associated signal sources.

According to an example implementation, a measurement error associated with a measurement source may be determined, for example, by comparing a measurement derived from the measurement source with one or more aspects of a location estimate and/or one or more measurements obtained from other measurement sources to provide a residual. Here, an estimate of an error associated with the measurement source may be quantified and/or represented as, for example, a mean square error derived from a history of measurements obtained and/or derived from the measurement source. As discussed above, an error estimate may also be quantified as a fixed value in a given set of units at a specified confidence level or number of standard deviations. An error estimate may also be quantified as a function of the location of the mobile station and/or as a function of such parameters as received signal strength. However, these are merely examples of how an estimate of a measurement error may be quantified according to a particular implementation, and claimed subject matter is not limited in this respect.

As pointed out above, estimated or expected errors associated with measurements from a measurement source may change with changes in an operating environment. As such, estimated or expected errors associated with a measurement source may depend, at least in part, on a location of a mobile station acquiring signals from a measurement source. Here, for example, a measurement error associated with AFLT measurements obtained by a mobile station from a base station may change and/or be dependent upon a particular sector where the mobile station is located. A measurement error may also be a function of signal strength and even a location within a sector.

In one particular implementation, location server 145 may update an estimate of measurement error associated with a measurement source based, at least in part, on measurements associated with the measurement source. For example, location server 145 may implement one or more Kalman filters, sign test filters, alpha-beta filters or similar software implementations to process measurements received over time and enable an estimate of a current measurement error associated with a particular measurement source. A mobile station may also implement these types of filters and process/filter one or more measurements. At least one of bias information or uncertainty/speed may be determined via the filtering. A current estimated measurement error for a particular base station, for example, may be updated based on new measurements via a filtering process. In some particular implementations, errors associated with newer or more recent measurements associated with a measurement source may have a larger bearing upon a determination of an updated current estimated measurement error than older or earlier measurements associated with the measurement source.

By utilizing new measurements to update an estimate of a measurement error associated with a particular beacon signal, for example, measurements obtained from such a beacon signal may be more appropriately weighted (versus measurements obtained from other beacon signals) in estimating a location of a mobile station 105. Thus, such an approach provides the advantage of adapting to variations in an operational environment that is not available with assumed static, a priori or global measurement error models.

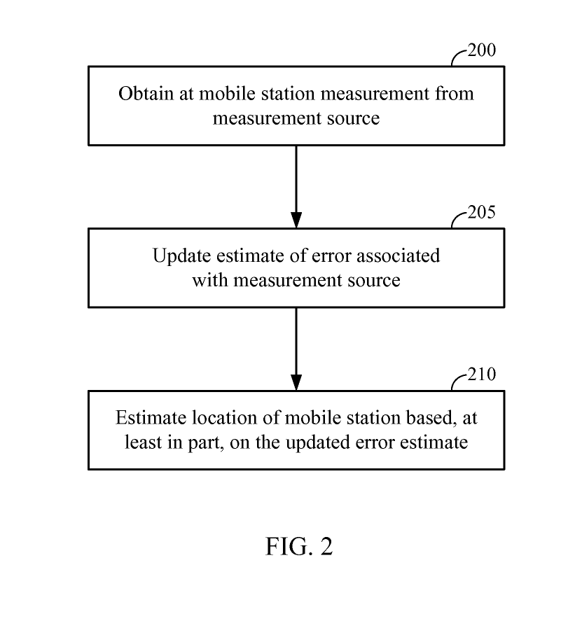

FIG. 2 is a flow diagram illustrating a process for estimating a location of a mobile station 105 according to one implementation. First, at operation 200, a measurement is obtained at mobile station 105 from a measurement source. As discussed above with respect to FIG. 1, such a measurement may be obtained from any one of several measurement sources such as SPS pseudorange measurements from an SPS and measurements from base stations of an AFLT system, just to name a couple of examples. Next, at operation 205, an estimate of a measurement error associated with the measurement source is updated based, at least in part, on the measurement obtained at operation 200. Finally, at operation 210, a location of such a mobile station 105 is estimated based, at least in part, on an updated estimated measurement error obtained at operation 205.

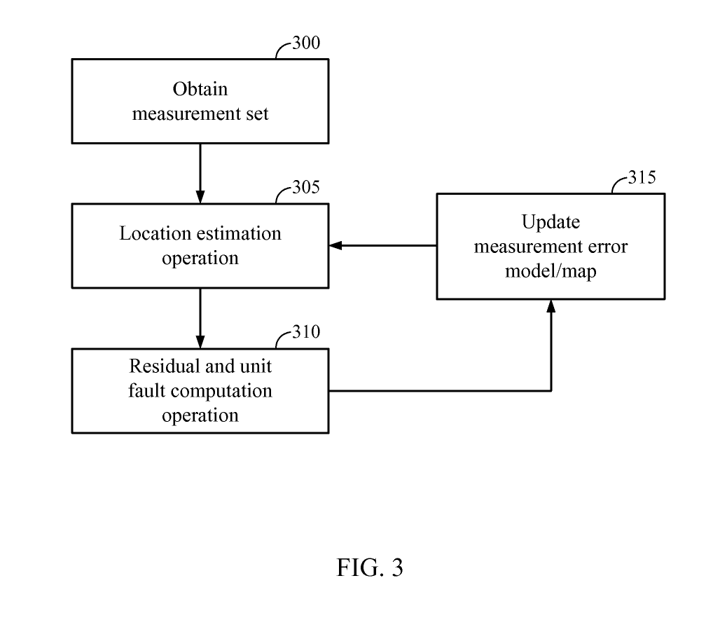

FIG. 3 is a flow diagram illustrating a process of estimating a location of a mobile station according to one particular implementation in which a mobile station obtains a set of measurements from measurement sources at operation 300 in support of determining a location estimate. Such measurements may include measurements of pilot signals transmitted by various base stations as part of an AFLT system, as well as measurements from other navigation systems, such as SVs in an SPS. Next, a location of a mobile station is estimated at operation 305. Operation 310 may compare measurements obtained at operation 300 with a location or position estimate determined at operation 305 to obtain residuals associated with measurements obtained at operation 300. Such residuals may then be used to update estimates of errors associated with particular measurement sources at operation 315. In estimating a location based upon measurements obtained at operation 300, operation 305 may appropriately weight such measurements based, at least in part, on updated error estimates obtained at operation 315.

In a particular implementation, operation 315 may update estimates of error measurements associated with measurement sources in a measurement error model/map. In addition to associating measurement error estimates with particular measurement sources, such a measurement error model/map may also associate such measurement errors with other conditions such as approximate location of a mobile station obtaining a measurement from the measurement source. Accordingly, measurements obtained by a mobile station at a location may be appropriately weighted in estimating the location using error estimates maintained and updated for an approximate location of the mobile station (e.g., in a sector of a base station or some subset thereof).

In one particular implementation, a measurement error model/map may indicate an entire area of coverage for which a location of a mobile station may be estimated. Depending upon which sector of such coverage area such a mobile station is located, for example, measurement errors associated with measurements from a particular base station may differ, as discussed. It should be noted that FIG. 3 illustrates a feedback process whereby estimates of error measurements associated with measurement sources in measurement error model/map may be periodically updated based on new measurements.

In one implementation, a spread of phase measurement errors associated with a measurement source (e.g., a base station as part of an AFLT system or SV in an SPS) may be an indicator of error that can be expected on future measurements from the measurement source. Thus, such a feedback loop of FIG. 3 may be realized with sector-specific error estimates for phase measurements if a position and clock state of a mobile station for which location is being determined is well known. Sector specific weighting may improve network-based position accuracy and improve a location error estimate. There may be other sources of environment-specific information, such as terrain types used in radio frequency (RF) propagation models, population density data, digital terrain elevation data (DTED), building height and density data, to name a few. Such pieces of information may be used to refine an error model along with more specific information, such as received signal strength, relative signal strength, elevation angle, and/or azimuth.

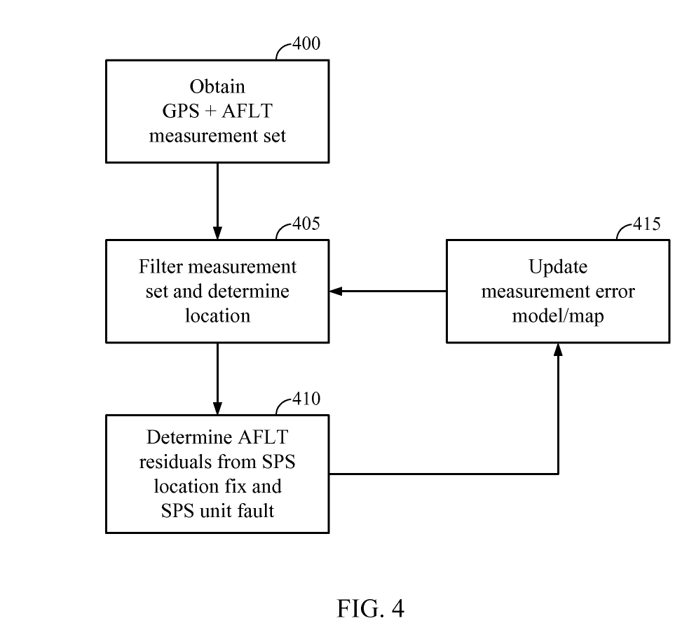

FIG. 4 is a flow diagram illustrating a process for determining a location of a mobile station according to one implementation. First, a mobile station obtains set of SPS measurements and AFLT measurements at operation 400. Operation 405 may filter measurements to estimate a location of the mobile station. In such filtering, weights may be assigned to measurements from such a set of AFLT measurements, as discussed above. In the event that a sufficient set of SPS measurements has been obtained, a location of the mobile station may be estimated entirely, or primarily, based on such a set of SPS measurements. Operation 410 may determine AFLT residuals from an SPS location/position fix and an SPS unit fault. Such an SPS unit fault may be determined based, at least in part, on a comparison of a calculated residual with an expected residual. Operation 415 may then update a measurement error model/map based, at least in part, on such AFLT residuals. Finally, such an updated measurement error model/map may be utilized to determine a location of a mobile station based on a subsequent set of AFLT measurements, according to one implementation.

FIG. 4 therefore illustrates a particular implementation of a hybrid system for determining locations based on either or both SPS and AFLT measurements. Hybrid measurement error estimates may be scaled appropriately, such that each measurement type and each particular measurement can be assigned an accurate error estimate. In particular implementations, SPS pseudorange measurements may be highly accurate in determining location and may serve as a reliable source upon which to base forward link calibration (FLC) and FLC uncertainty estimates. With highly accurate SPS pseudorange measurements, it may be difficult to find an accurate and inexpensive truth source for location estimates taken in an operational system. However, with extra SPS pseudorange measurements, beyond a minimum 3-4 that may be required for an accurate location estimate, it may be possible to calculate “Unit Fault,” e.g., a ratio of observed to expected weighted residuals. Unit Fault may be determined from the following equations. The quadratic form of residuals obtained in the weighted least squares model may be one of the more important quantities:

Ω=\hat{r}^{T}W\hat{r}, where Omega denotes, e.g., a weighted sum of square errors, \hat{r} denotes the residual vector/matrix, T denotes a linear transpose operation, and W is the weight matrix formed from a priori error estimates.

Another quantity estimated during a weighted least squares model is a variance factor, also known as “unit variance”:

$${\hat{σ}}_{o}^{2} = \frac{Ω}{n - u} ,$$

where n denotes a number of measurements or observations, and u denotes a number of degrees of freedom or unknown values.

Unit fault may be defined as the square root of the unit variance. It may have a property of being a ratio of magnitude of the observed to predicted residuals.

A map of unit faults may be created and maintained to help scale expected errors on future measurements. It should be noted that component unit faults may be readily formed, using similar computational methods, to focus on the measurement types of interest.

Thus, in a dense urban canyon, for example, where long multipath may be expected, a priori SPS pseudorange measurement error estimates may increase appropriately, whereas in a more open environment, a priori measurement error estimates may be relatively small. Of course, there may be other sources for such environment-specific information, such as terrain types used in standard RF propagation models, population density data, digital terrain elevation data (DTED), building height and density data, to name a few. It should be appreciated that all of these pieces of information may also be used to refine such an a priori error model for SPS along with more specific information, such as received signal strength, relative signal strength, elevation angle, and/or azimuth.

For both SPS and ground-based AFLT phase measurements, a generalized model taking into account one or more of such factors discussed above may be created using multiple regression, parametric, and/or iterative optimization techniques. This may be performed off-line using a sample of measurement data and the metrics of interest, creating a general model. Alternatively, it may be performed somewhat automatically for each smaller region of interest, creating a best fit for each region. Sizes of regions may be expanded, as necessary, to assure statistical confidence. Proximity to source input may be used to weight filter input data for each region. Such a weighting function may be based at least in part upon a degree of correlation observed with increasing distance from a target location.

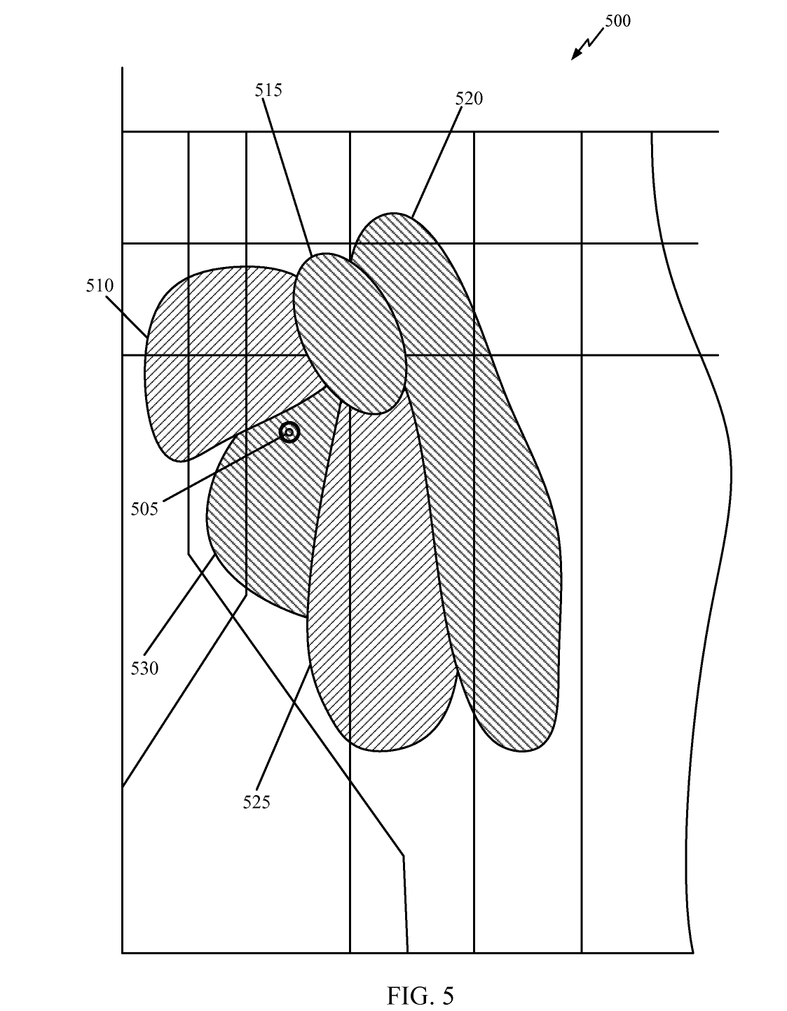

FIG. 5 illustrates a measurement error model/map 500 according to one particular implementation. Measurement error model/map 500 may indicate measurement errors in various portions of a geographical area near a base station 505, for example. Measurement error model/map 500 may indicate different estimates of measurement areas for various portions of a geographic map. Reasons for such differing measurement error estimates may be due to different elevations at different portions of the map, or the presence of tall buildings, for example, in certain portions of a map. In this example, there are several different geographical areas associated with different measurement errors. For example, a first geographical area 510 may be associated with a first estimate of measurement errors, a second geographical area 515 may be associated with a second estimate of measurement errors, a third geographical area 520 may be associated with a third estimate of measurement errors, a fourth geographical area 525 may be associated with a fourth estimate of measurement errors, and a fifth geographical area 530 may be associated with a fifth estimate of measurement errors.

It should be appreciated that each of the geographical areas may have a different measurement error estimation model associated with it. Moreover, each of the geographical areas may have a different geographical size. Measurement error model/map 500 of FIG. 5 illustrates one example and it should be appreciated that a measurement error model/map 500 may be depicted in other ways. For example, a measurement error model/map may include a grid corresponding to specific locations in a coverage area, and a specific error estimate may be associated with each point on the grid.

In developing a measurement error model/map according to an example, regions of a coverage area for which location information may be obtained may be defined in a regular grid or cell pattern (square or hexagonal, for example). In one particular implementation, a smallest region may be assigned to each cell sector's serving coverage area, such that an appropriate measurement error model may be created, maintained, and used for each sector. However, any reasonable grouping of sectors or shapes of interest may be used, and such a measurement error model appropriate for a given set of measurements may be looked up based upon a best estimate of a mobile station's location, or an association with a particular sector, base station, or access point, for example.

As discussed above, a location of a mobile station may be estimated from an aggregation of measurement data received from multiple measurement sources. Here, such measurement data aggregation may take place in a network entity such as a location server, at base stations, or at a base station controller. Furthermore, such measurement data may be stored in a variety of network entities, as well as in a mobile station obtaining such measurement data. Here, in a particular implementation, such a mobile station may request and receive such information or may itself aggregate such information as measurements are obtained at the mobile station. Such a mobile station may also share such information with nearby mobile stations in a peer-to-peer network or with one or more data aggregators. Such a location/position may be estimated in such a location server or in a similar part of a wireless network, in which case error estimate modeling/mapping information may be stored in a manner similar to a terrain elevation database or a base station almanac. That is, error model filter states may be stored in the same units as those of a base station almanac (by sector) or terrain elevation database (grid postings). Because such error mapping information may be stored in such a base station almanac or terrain elevation database, such error mapping information may therefore be re-used on indexing functions of these databases. That is, a single pointer to an almanac entry may then be resolvable to allow using software to access all information about the entry, including, for example, ID parameters, positioning information, coverage range information and multipath mapping.

In one particular implementation, a median and spread from 75th to 25th percentile of pilot phase residuals from GPS location estimates in each sector may be estimated as error estimates by using a sign testing filter. Such a median may be used to correct forward link calibration (FLC) measurements. Spread (and number of points) may be used to determine FLC uncertainty. Such a spread may be used as an input to a priori error estimates for subsequent measurement sets. Such a spread, itself, may be used as an a priori error estimate or used to refine a model that uses other inputs, such as received signal strength, relative signal strength, estimated range from antenna, path loss (incorporating an antenna model), correlation peak shape, SPS measurement availability and signal strength, to name a few examples.

For SPS measurement weighting, unit fault statistics within sectors may be used to help tailor SPS error estimates to a corresponding local environment. A median unit fault may be estimated using a sign testing filter, for example, and this number is used to shape and/or scale an a priori SPS error estimate model, along with received signal strength, correlation peak shape, elevation angle, and/or standardized environment type.

It should be appreciated that harmonizing error estimates between SPS and AFLT measurements may assist in appropriately weighting such measurements in a mixed (hybrid) solution.

A similar feedback scheme may be used to improve coverage area estimates, as well, shaping and scaling an expected coverage area of sectors as a function of relative and absolute signal strength, and/or relative phase, for example. That is, an expected location and uncertainty of a mobile station within a cell sector may be a function of received signal strength and sector size. Models may be refined to provide more accurate predictions on a sector-by-sector basis, based upon data taken in such a sector over time. Such models may, for example, provide a more accurate measurement error model/map such as that shown in FIG. 5 and utilized by methods of FIG. 3 or 4.

In the event that handset-specific biases between GPS and ground-based measurements are observed, these too may be estimated and removed. For example, a separate set of filters may be utilized for each handset or mobile station.

Error estimates may be automatically updated based on location position error estimates as they are determined or received from a location server, for example. A sign test filter may be utilized to test location or position error estimates provided to the filter. If an incoming pseudorange residual is greater than expected, a state of the filter may be increased. If, on the other hand, an incoming pseudorange residual is less than expected, a state of the filter may be decreased. A spread of residuals between, for example, the 25th percentile and 75th percentile, may also be filtered via similar sign test methods. The size of the spread and the number of samples received may indicate how much to adjust a bias term. Sign test filters may provide various advantages as a result of being inherently compact and stable.

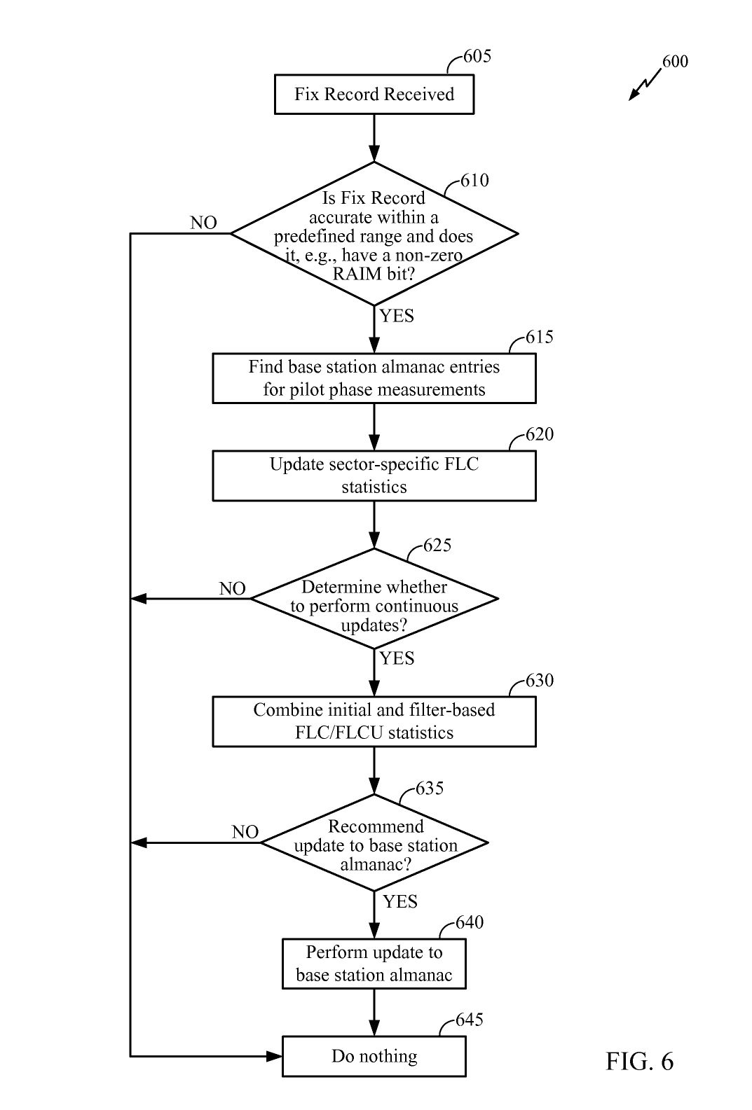

FIG. 6 is a flow diagram 600 illustrating a process for updating forward link calibration (FLC) measurements according to one implementation. Such a process may be utilized to continuously calibrate and check calibration values for pilot phase measurements. Such calibration values, and their uncertainties may be stored in a base station almanac and may subsequently be utilized by a Position Determination Module (PDM) while processing pilot phase measurements. Such calibration values are derived from pilot phase residuals from highly accurate (e.g., <50 meter Horizontal Estimated Position Error (HEPE)) GPS fixes that are also verified according to a Receiver Autonomous Integrity Monitoring (RAIM) process. For every location fix determined to be accurate within a <50 meter HEPE, pilot phase residuals for all pilots that were looked up may be added to real-time data storage kept for each respective sector/frequency pair. FLC and FLC Uncertainty (FLCU) values may subsequently be determined from these raw values, and updates to base station almanac values may be performed, as necessary. Such an update process may be run in real-time, periodically, or on command.

Referring to FIG. 6, a FixRecord is received at operation 605. A “FixRecord,” as used herein, may refer to an estimated location or position of a mobile station based on one or more GPS or AFLT measurements, as well as any other location-related measurements. Next, at operation 610, a determination is made as to whether the position estimate of the FixRecord has an accuracy estimate within a predefined range and has passed a RAIM test. A predefined range may comprise, for example, a range of <50 meters HEPE. Accuracy of a FixRecord may be determined based on a combination of a priori pseudorange error estimates, coverage area size estimates, measurement geometry and such a posteriori error estimate inputs as unit fault, for example. A RAIM test may be used to determine whether a fix has been determined using a faulty measurement. A FixRecord having an accuracy within a predefined distance range and a passing RAIM test may comprise a location or position fix determined based on signals from a GPS source. Signals from a GPS source may, for example, be associated with a low error estimate and there may be strong confidence associated with such an error estimate.

If “no,” at operation 610, processing proceeds to operation 645. If “yes” at operation 610, on the other hand, processing proceeds to operation 615 where base station almanac entries for pilot phase measurements corresponding to the FixRecord are located. Sector-specific FLC statistics may subsequently be updated in a base station almanac at operation 620. Next, a determination is made as to whether to perform continuous updates to a base station almanac at operation 625. If “no” at operation 625, processing proceeds to operation 645. If “yes” at operation 625, on the other hand, processing proceeds to operation 630 at which point initial and filter-based FLC/FLCU statistics are combined. Here, initial FLC and FLCU values may serve as a consistent starting point, such that new information may change a model only as confidence increases. Such initial values may be associated with a base station manufacturer or be carrier-provided. Such initial values may also be sufficiently broad to simply reflect a specified timing uncertainty of a base station. A “yes” or “no” determination made be made at operation 625 based on previously programmed settings. Continuous updates may be appropriate for a system that supports active updates (e.g., one where a mobile station may be contacted by a server, rather than waiting for a mobile station to request an update). Such a system may typically require more network bandwidth and may not be desirable in some implementations.

Next, a determination is made at operation 635 regarding whether to recommend an update to a base station almanac with combined initial and filter-based FLC/FLCU statistics. Criteria for determining whether to make such a recommendation include previously programmed settings, for example, or a degree of change from previous values, or an amount of time passed since a previous update. If “no” at operation 635, processing proceeds to operation 645. If “yes” at operation 635, on the other hand, processing proceeds to operation 640 at which point a base station almanac is updated with combined initial and filter-based FLC/FLCU statistics. If process flow reaches operation 645, the process ends without taking any additional actions.

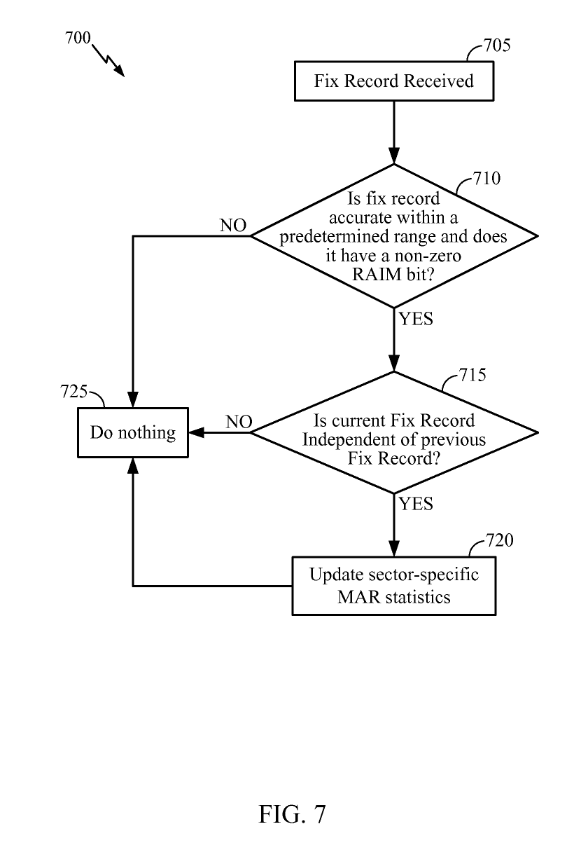

FIG. 7 is a flow diagram 700 illustrating a process for updating Maximum Antenna Range (MAR) values. MAR value is typically thought of as a certain percentile distance between a mobile station and a base station, typically in a range of 90% to 99.7%. MAR values may be used as an indication of a size of a given sector, and therefore a degree of uncertainty associated with a sector-based positioning input. At operation 705 of FIG. 7, a FixRecord is received. Next, at operation 710, a determination is made regarding whether a position fix is accurate within a predetermined uncertainty range and whether it has passed a RAIM test. If “no” at operation 710, processing proceeds to operation 725. If “yes,” on the other hand, a determination is made at operation 715 regarding whether a current FixRecord is independent of one or more previous FixRecords. A FixRecord may be considered to be independent from one or more previous FixRecords if its position is at least a predefined distance away from the one or more previous FixRecords. For example, a current fix may be independent of a previous fix if it is at least 100 meters away from the previous fix. The degree of independence of a fix may also be based on the time between updates and/or the independence of the mobile station (e.g., whether or not two fixes of interest are from the same mobile station.)

Such a measurement of independence may be utilized to ensure that a single value within a small portion of a sector does not unduly influence the MAR statistics. A concern is that a single outlier measurement may bias a MAR for the sector with highly correlated inputs.

Referring back to FIG. 7, if a determination is made at operation 715 that a current FixRecord is not independent of a previous FixRecord, then processing proceeds to operation 725. If, on the other hand, such a current FixRecord is independent of a previous FixRecord, processing proceeds to operation 720, where sector-specific MAR statistics are updated in, for example, a base station almanac. If process flow reaches operation 725, the process ends without taking any additional actions.

The process discussed above with respect to FIG. 7 may continuously calibrate and perform “sanity checks” (e.g., to determine whether a received value is reasonable) on a MAR value for each sector. A MAR value may be stored in a base station almanac and may be used by a position determination module or a mobile station when processing pilot phase measurements. For every qualifying location fix (e.g., a fix accurate to within <100 meters HEPE and RAIM-checked), a range to the serving sector center may be given to a simple sign-testing filter associated with the sector of interest. This filter's states may be used to improve on an internally held MAR estimate.

Such a feature may provide a continuous sanity check and adjustment of the MAR for each sector in the BSA. The process of FIG. 7 may be performed in real-time, as each FixRecord is received, but may also be run in a batch processing mode, if necessary.

The current “best” value of the MAR may comprise a weighted average of the initial value and observed ranges from the serving center or sector antenna. Initial values may be taken from an initial base station almanac for that sector. If no such input is available, such initial values may instead be provided based upon bulk properties of a plurality, or all, base stations in a network. A MAR value may also be estimated based upon a distance to nearby base stations, multiplied by some pre-determined factor, appropriate to a given air interface and/or a sensitivity of supported mobile stations.

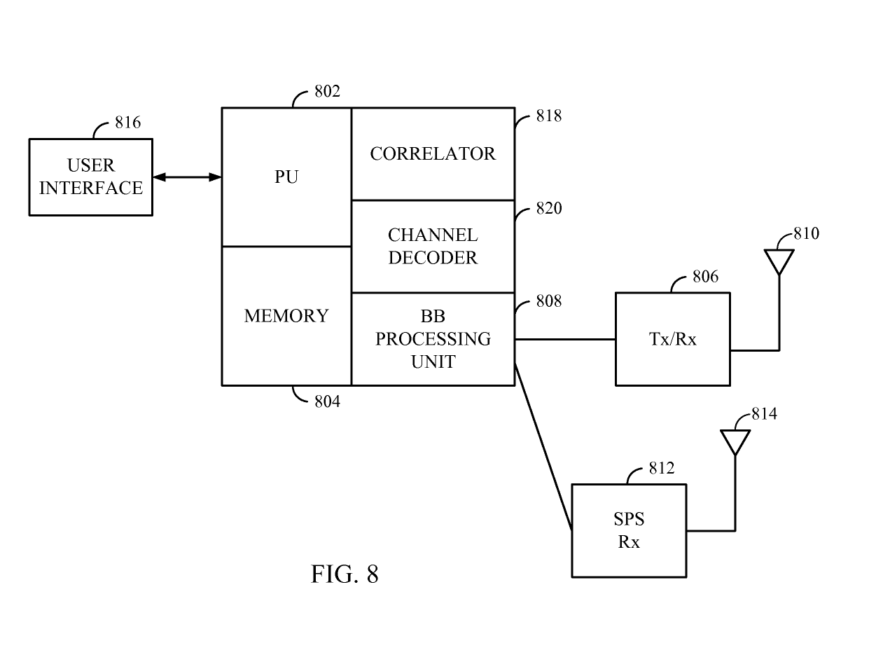

FIG. 8 shows a particular implementation of a mobile station in which radio transceiver 806 may be adapted to modulate an RF carrier signal with baseband information, such as voice or data, onto an RF carrier, and demodulate a modulated RF carrier to obtain such baseband information. An antenna 810 may be adapted to transmit a modulated RF carrier over a wireless communications link and receive a modulated RF carrier over a wireless communications link.

Baseband processing unit 808 may be adapted to provide baseband information from processing unit (PU) 802 to transceiver 806 for transmission over a wireless communications link. Here, PU 802 may obtain such baseband information from an input device within user interface 816. Baseband processing unit 808 may also be adapted to provide baseband information from transceiver 806 to PU 802 for transmission through an output device within user interface 816.

SPS receiver (SPS Rx) 812 may be adapted to receive and demodulate transmissions from transmitters through SPS antenna 814, and provide demodulated information to correlator 818. Correlator 818 may be adapted to derive correlation functions from the information provided by receiver 812. For a given pseudo noise (PN) code, for example, correlator 818 may produce a correlation function defined over a range of code phases to set out a code phase search window, and over a range of Doppler frequency hypotheses. As such, an individual correlation may be performed in accordance with defined coherent and non-coherent integration parameters. It should be appreciated that longer coherent integration times imply use of relatively narrower Doppler bins.

Correlator 818 may also be adapted to derived pilot-related correlation functions from information relating to pilot signals provided by transceiver 806. This information may be used by a mobile/subscriber station to acquire wireless communications services.

Channel decoder 820 may be adapted to decode channel symbols received from baseband processing unit 808 into underlying source bits. In one example where channel symbols comprise convolutionally encoded symbols, such a channel decoder may comprise a Viterbi decoder. In a second example, where channel symbols comprise serial or parallel concatenations of convolutional codes, channel decoder 820 may comprise a turbo decoder.

Memory 804 may be adapted to store machine-readable instructions, which are executable to perform one or more of processes, examples, or implementations, which are described or suggested. PU 802 may be adapted to access and execute such machine-readable instructions. Through execution of these machine-readable instructions, PU 802 may direct correlator 818 to analyze the SPS correlation functions provided by correlator 818, derive measurements from the peaks thereof, and determine whether an estimate of a location is sufficiently accurate. However, these are merely examples of tasks that may be performed by a PU in a particular aspect and claimed subject matter in not limited in these respects.

In a particular example, PU 802 at a mobile/subscriber station may estimate a location the mobile/subscriber station based, at least in part, on signals received from SVs as illustrated above.

By utilizing a history of measurements to determine and periodically update measurement errors associated with certain areas of a coverage area, as discussed above, a location of a mobile station may be determined with more accuracy than would be possible if only static a priori measurement errors were utilized.

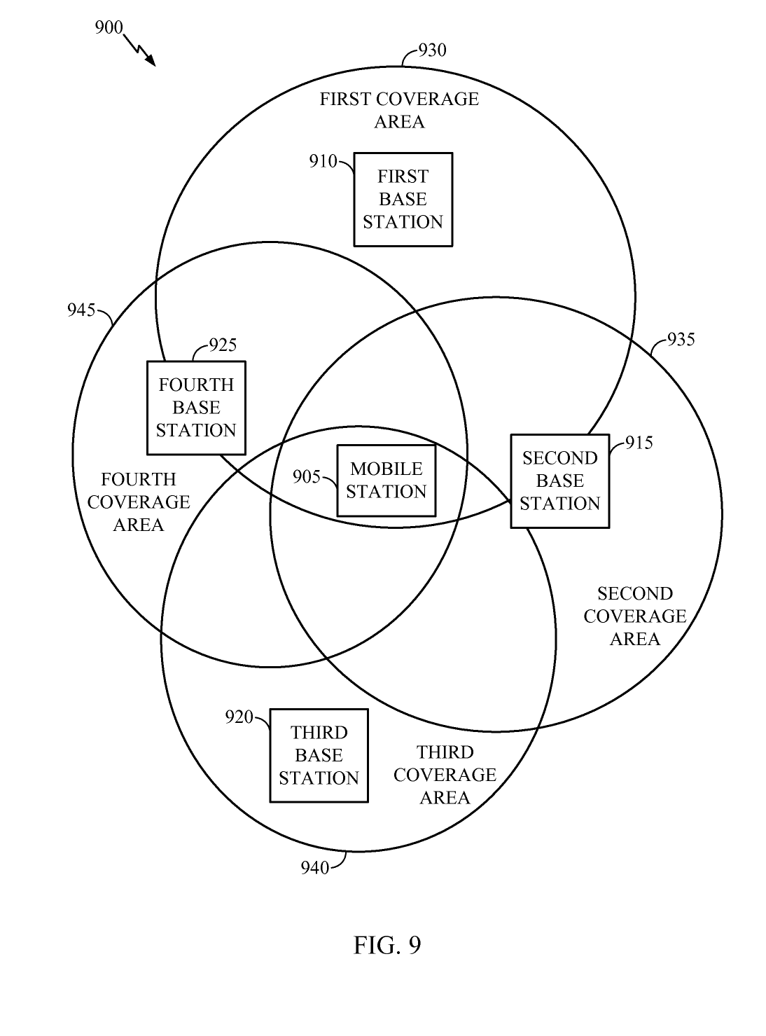

FIG. 9 is a diagram illustrating a system 900 for determining a location of a mobile station 905 according to one implementation. In this example, mobile station 905 may desire to determine its location. For example, mobile station 905 may have recently been powered on or moved to a new area and desires location information. There are several nearby base stations or other wireless transmission elements that may transmit pilot signals to mobile station 905. For example, a first base station 910, second base station 915, third base station 920, and fourth base station 925 may each transmit pilot signals. In this example, first base station 910 provides wireless service to a first coverage area 930, second base station 915 provides wireless service to a second coverage area 935, third base station 920 provides wireless service to a third coverage area 940, and fourth base station 925 provides wireless service to a fourth coverage area 945.

In this example, mobile station 905 is within the coverage areas of each of the four illustrated base stations. Mobile station 905 may receive pilot signals from each base station and may, for example, receive wireless service from a base station providing the pilot signal having the strongest signal as received by the mobile station 905. Pilot signals from other base stations may be utilized to estimate respective ranges from mobile station 905 to each of such base stations. For example, if geographical location of at least three base stations is known, and ranges between mobile station 905 and each of such base stations are determined, a location of mobile station 905 may be determined via triangulation, for example.

A range between mobile station 905 and a base station may be determined based on a measured time delay between a time at which a pilot signal, or other type of signal, is transmitted by such a base station and a time at which such a pilot signal is received by mobile station 905. For example, a particular base station may periodically transmit a pilot signal at a time known a priori to mobile station 905, and the timing delay between the transmission of the pilot signal and receipt at mobile station 905 may be measured. However, as discussed above, there are certain geographical factors that may affect an amount of timing delay for such a pilot signal, or other signal, to be received by mobile station 905. For example, a pilot signal may experience an additional delay to reach mobile station 905 if there is no direct line-of-sight path between a tower transmitting a pilot signal for a base station and mobile station 905. There may be, for example, valleys or hills present and a signal may be reflected off one or more valleys or hills before it is received by mobile station 905. To account for such geographical variances, a timing error associated with an area where a mobile station 905 is located may be utilized to determine a range between mobile station 905 and a base station transmitting a pilot signal. In one example, a median timing error and a spread of timing errors may be provided to mobile station 905 or to some other device capable of estimating a range between mobile station 905 and such a base station. Such median timing error and spread of timing errors may be based upon previously measured timing errors and may be stored in a base station almanac or some other accessible database or server.

In one example, a beacon transmission received by mobile station 905 may include an identifier to identify a base station transmitting such a pilot signal. Mobile station 905 may subsequently access one or more files containing timing errors associated with such a base station. For example, such files may be stored in a base station almanac and may be downloaded by mobile station 905. Alternatively, a set of files containing timing errors may be automatically transmitted to mobile station 905 by a base station or other device having a transmitter associated with such a base station almanac.

As discussed above, a base station may provide wireless service to one or more sectors within a coverage area. In one example, a base station may provide wireless service to three sectors, for example, and may provide wireless service via more than one channel in each sector. For example, wireless service may be provided via three different channels in each sector. A sector providing wireless service to a mobile station is referred to herein as a serving sector.

Information about previously observed timing delays/timing calibration errors may be stored within a base station almanac for each sector and for each frequency provided within each sector, for example. Such estimated timing delays may be utilized to determine a range between a mobile station and a base station providing wireless service to the mobile station. Information about timing calibration errors associated with a serving sector providing wireless service may be utilized to estimate a range between a mobile station and a base station associated with the serving sector. By providing timing calibration errors for a sector, as opposed to timing calibration errors for an entire base station, a range between a mobile station and a base station may be estimated with greater accuracy than would be possible if timing calibration errors for an entire base station or group of base stations were utilized instead.

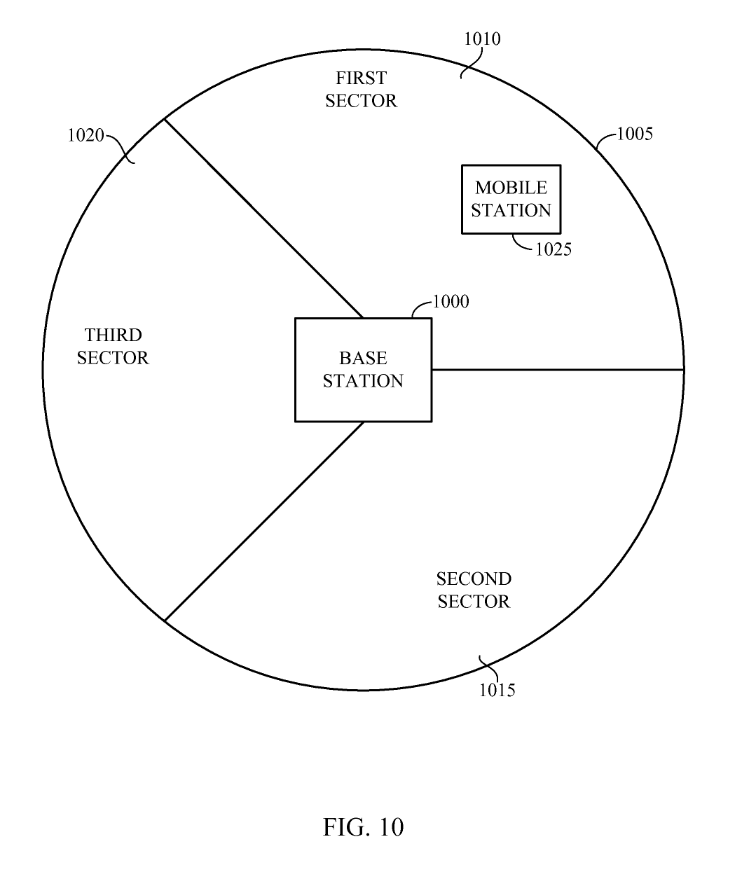

FIG. 10 illustrates a base station 1000 and a coverage area 1005 according to one implementation. As shown, base station 1000 may provide wireless service via various sectors to coverage area 1005. In this example, base station 1000 provides wireless service via a first sector 1010, second sector 1015, and third sector 1020. In some implementations, base station 1000 may provide wireless service via more or fewer than three sectors. In the event that, for example, a mobile station 1025 receives wireless service from first sector 1010, first sector 1010 would therefore be a serving sector providing such wireless service to mobile station 1025.

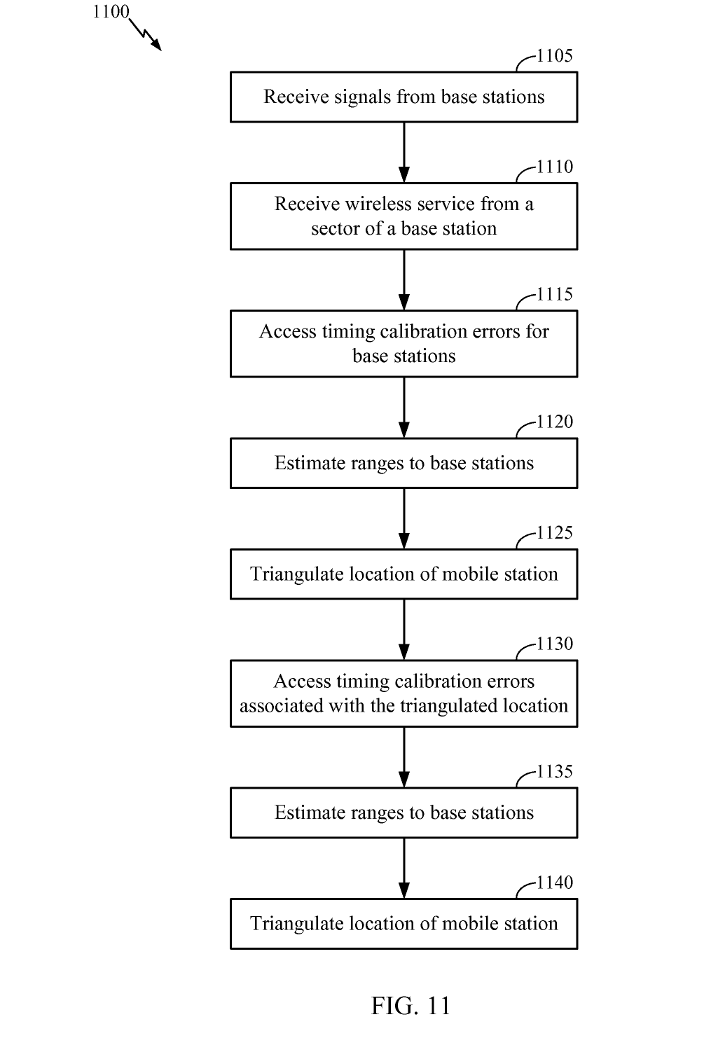

FIG. 11 is a flow diagram of a process 1100 for determining a location of a mobile station according to one implementation. First, at operation 1105, a mobile station receives signals from one or more base stations or other wireless transmission elements. Such signals may, for example, comprise pilot signals. Next, at operation 1110, a mobile station may receive wireless service from a particular sector of a base station. As discussed above, such a sector may be referred to as a serving sector. Next, at operation 1115, timing calibration errors for base stations providing pilot signals may be accessed. In one implementation, a pilot signal may contain an identifier to uniquely identify a base station from which it is transmitted. In some implementations, a structure of a pilot signal may provide some means of identification, although such information may be ambiguous. A mobile station may subsequently retrieve files from an almanac or other database containing timing calibration errors associated with various base stations and/or sectors of base stations. For example, a mobile station may have information indicating how a particular almanac is to be accessed and/or a location of the almanac. Alternatively, a pilot signal may include an identifier to inform a mobile station of a location and/or way to access such an almanac.

Referring back to FIG. 11, at operation 1120, timing calibration errors are utilized, in part, to estimate ranges from a mobile station to one or more base stations. A timing calibration error associated with a serving sector may be utilized for a base station providing wireless service to a mobile station. At operation 1125, a location of a mobile station may be triangulated based upon such ranges. Different weights may be applied to the various pseudoranges based on certain criteria regarding a likely accuracy of such estimated pseudoranges. These criteria may include signal strength and historical accuracy.

After a location of a mobile station has been determined, a feedback process may be implemented to further refine the location with greater accuracy. At operation 1130, timing calibration errors associated with the previously determined location of the mobile station are accessed or retrieved. At this stage, timing calibration errors may be accessed that are associated with a relatively small geographical area, such as a 100.0 meter×100.0 meter block of space, as opposed to a single timing calibration error associated with a much larger serving sector or coverage area. By retrieving calibration errors associated with a relatively small geographical area, ranges between a mobile station and one or more base stations may be estimated with much more accuracy than would be possible with calibration errors associated with an entire serving sector or coverage area. If a sufficient number of observations is not available within the smallest grid square, a range of grid squares may be expanded to increase a number of observations under consideration.

At operation 1135, such estimated calibration errors may be utilized while estimating ranges between a mobile station and one or more base stations. At operation 1140, a location of a mobile station may be triangulated or otherwise determined with a relatively high degree of accuracy.

Additional factors may also be considered while determining a range between a mobile station and a base station. For example, elevation may be included in a grid or map of calibration errors. Elevations may be used as an additional input to a navigation solution, assuming that a mobile station is close to the surface of the earth. Elevations may also be used to determine whether a mobile station is likely to be in a line-of-sight (LOS) or non-line-of-sight (NLOS) condition. Such likelihoods may be used as parameters in a measurement error estimation model.

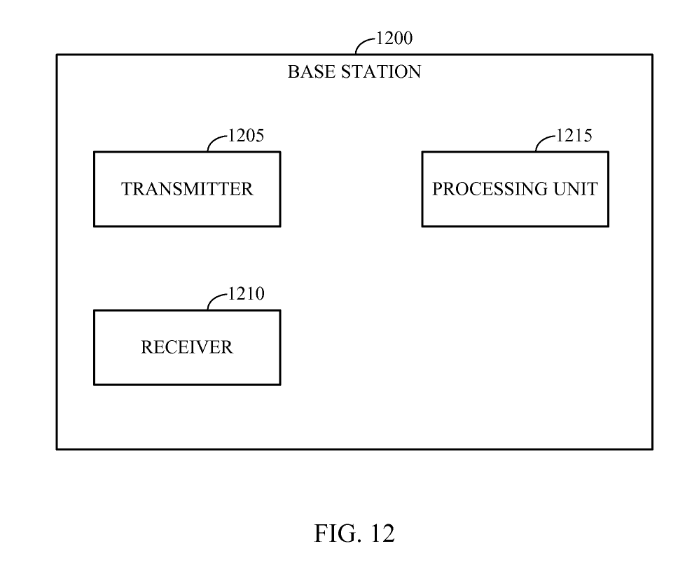

FIG. 12 illustrates aspects of a station 1200 according to one implementation. As shown, base station 1200 may include a transmitter 1205, receiver 1210, and processing unit 1215. Transmitter 1205 may transmit signals to a mobile station and receiver 1210 may receive signals from the mobile station. Processing unit 1215 may control operation of transmitter 1205 and/or receiver 1210.

Timing calibration errors may be observed over time and reported by mobile stations, for example, to a base station almanac server and utilized to update values reflected in a grid or mapping of a geographical area.

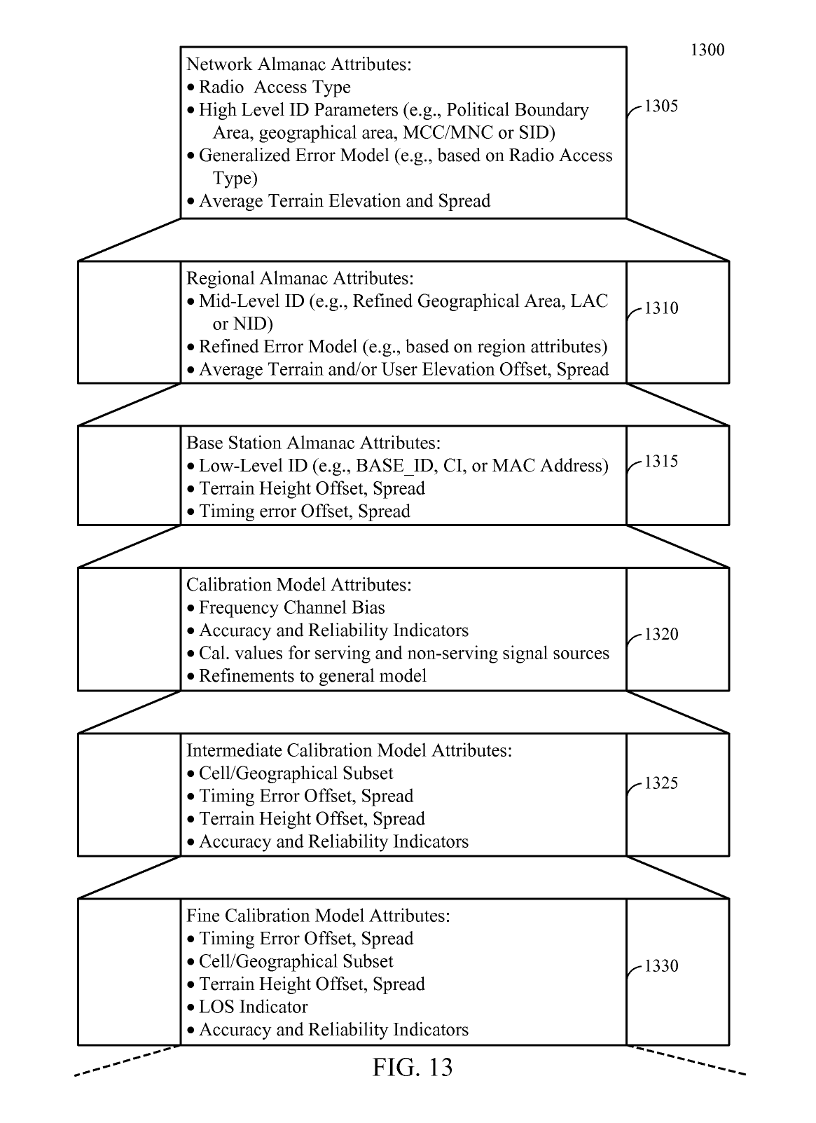

FIG. 13 illustrates aspects of calibration timing error information stored in a base station almanac according to one implementation. High level diagram 1300 illustrates network almanac attributes 1305, regional almanac attributes 1310, base station almanac attributes 1315, calibration model attributes 1320, intermediate calibration model attributes 1325, and fine calibration model attributes 1330. It should be appreciated that alternative and/or additional criteria may be considered in some implementations. Calibration timing error information illustrated in high level diagram 1300 may be utilized to generate a model of calibration timing errors associated with various locations of a geographical area.

Network almanac attributes 1305 include information such as radio access type, and high level identifier parameters such as a political boundary area, information about a size of a geographical area, Mobile Country Code (MCC) or Mobile Network Code (MNC), and System Identifier Number (SID). Network almanac attributes 1305 may further include a generalized error model (e.g., based at least in part on a radio access type), and an average terrain elevation and spread of a geographical area.

Regional almanac attributes 1310 may include information such as a mid-level identifier (e.g., a refined geographical area, Location Area Code (LAC), or Network Interface Device (NID)). Regional almanac attributes 1310 may also include a refined error model based at least in part on attributes of the covered geographical region. Regional almanac attributes 1310 may further include information about an average terrain and/or user elevation offset, and spread. Spread may be a simple measure, such as a standard deviation, or it may comprise a difference between two percentile values, such as the difference between the 75^{th} and 25^{th} percentile pseudorange residuals.

Base station almanac attributes 1315 may include a low level identifier such as, for example, a base station identifier (“BASE_ID”), cell identifier (“CI”), or Machine Addressable Content (MAC) address. Base station almanac attributes 1315 may also include terrain height offset and spread, and timing error offset and spread.

Calibration model attributes 1320 may include information such as channel bias, accuracy and reliability indicators. Reliability indicators may include a number of data points used to create a calibration, timeliness, source, or any other information that might help characterize reliability of calibration parameters. Calibration model attributes 1320 may also include calibration values for serving and non-serving signal sources and refinements to a general model. Refinements may include further offsets on a finer based grid or further fit parameters in a curve fit of calibration input data, for example.

Intermediate calibration model attributes 1325 may include information such as cell/geographical subset, timing error offset/spread, a terrain height offset/spread, and accuracy and reliability indicators.

Fine calibration model attributes 1330 may include information such as timing error offset/spread, a cell/geographical subset, a terrain height offset/spread, a LOS indicator, and accuracy and reliability indicators.

Various types of information shown in FIG. 13 may be utilized to generate a model of timing error estimates for a given geographical area.

It should be appreciated that a process of estimating the velocity of a mobile station may be similar to a process of estimating its location. Doppler or delta-range measurements may be available, providing a pseudoDoppler estimate that may be used to determine a velocity of a mobile station via use of a navigation filter similar to one which may be used to estimate a location/position of the mobile station. Error estimates and associated weights for such Doppler or delta-range measurements may be determined and managed using techniques similar to those discussed above for determining a weight for a ranging measurement.

Circuitry, such as transmitters and/or receivers may provide functionality, for example, through the use of various wireless communication networks such as a wireless wide area network (WWAN), a wireless local area network (WLAN), a wireless personal area network (WPAN), and so on. The terms “network” and “system” are often used interchangeably. The terms “location” and “position” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network, and so on. A CDMA network may implement one or more radio access technologies (RATs) such as CDMA2000, Wideband-CDMA (W-CDMA), and so on. CDMA2000 includes IS-95, IS-2000, and IS-856 standards. A TDMA network may implement Global System for Communications (GSM), Digital Advanced Phone System (D-AMPS), or some other RAT. GSM and W-CDMA are described in documents from a consortium named “3rd Generation Partnership Project” (3GPP). CDMA2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be used for any combination of WWAN, WLAN and/or WPAN. The techniques may be implemented for use with an Ultra Mobile Broadband (UMB) network, a High Rate Packet Data (HRPD) network, a CDMA2000 1X network, GSM, Long-Term Evolution (LTE), and/or the like.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

The methodologies may be used with positioning determination systems that utilize pseudolites or a combination of satellites and pseudolites. Pseudolites are ground-based transmitters that broadcast a PN code or other ranging code (similar to a GPS or CDMA cellular signal) modulated on an L-band (or other frequency) carrier signal, which may be synchronized with GPS time. Each such transmitter may be assigned a unique PN code so as to permit identification by a remote receiver. Pseudolites are useful in situations where signals from an orbiting satellite might be unavailable, such as in tunnels, mines, buildings, urban canyons or other enclosed areas. Another implementation of pseudolites is known as radio-beacons. The term “satellite”, as used herein, is intended to include pseudolites, equivalents of pseudolites, and possibly others. The term “SPS signals,” as used herein, is intended to include SPS-like signals from pseudolites or equivalents of pseudolites.

As used herein, a mobile station (MS) refers to a device such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile station.”

Some portions of the detailed description above are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. For example, a specific computing apparatus may comprise one or more processing units programmed with instructions to perform one or more specific functions.

Methodologies described herein may be implemented by various means depending upon applications according to particular features and/or examples. For example, such methodologies may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices designed to perform the functions described herein, and/or combinations thereof.

For a firmware and/or software implementation, certain methodologies may be implemented with modules (e.g., procedures, functions, and so on) that perform the functions described herein. Any machine readable medium tangibly embodying instructions may be used in implementing the methodologies described herein. For example, firmware/software codes may be stored in a memory of a mobile station and/or an access point/femtocell and executed by a processing unit of the device. Memory may be implemented within a processing unit and/or external to the processing unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. A computer-readable medium may take the form of an article of manufacture. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processing units to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

“Instructions” as referred to herein relate to expressions that represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands that are executable by a processing unit having a command set which includes the encoded commands. Such an instruction may be encoded in the form of a machine language understood by the processing unit. Again, these are merely examples of an instruction and claimed subject matter is not limited in this respect.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

What is claimed is:

1. A method comprising:
obtaining one or more measurements, at a mobile station, based at least in part on one or more signals received by the mobile station from one or more signal sources;
updating estimates of measurement errors associated with at least one of the one or more signal sources based, at least in part, on one or more historical measurements associated with the at least one of the one or more signal sources; and
estimating a location of the mobile station based, at least in part, on the one or more measurements and the updated estimates of measurement errors associated with the at least one of the one or more signal sources.

2. The method of claim 1, wherein at least one of the one or more signal sources comprises a satellite vehicle (SV) as part of a Satellite Positioning System (SPS), and at least one of the one or more signal sources comprises one or more terrestrial base stations.

3. The method of claim 2, wherein the one or more terrestrial base stations comprise a Code Division Multiple Access (CDMA) 2000 system.

4. The method of claim 1, wherein the estimating a location of the mobile station is performed within an asynchronous system.

5. The method of claim 4, further comprising estimating a frame timing relationship of the asynchronous system.

6. The method of claim 4, further comprising estimating a timing uncertainty of the asynchronous system.

7. The method of claim 1, further comprising filtering the one or more measurements.

8. The method of claim 7, wherein at least one of bias information or uncertainty/speed is determined via the filtering.

9. The method of claim 1, further comprising estimating at least one coverage area associated with the one or more measurement sources.

10. The method of claim 9, further comprising estimating a size or a confidence interval for the size of the at least one coverage area.

11. The method of claim 1, further comprising obtaining at least one pseudorange measurement to at least one of the one or more signal sources.

12. The method of claim 11, further comprising updating the estimates of the measurement errors with the at least one pseudorange measurement.

13. The method of claim 1, wherein the estimates of measurement errors comprise measurements obtained over a predetermined time interval.

14. The method of claim 1, wherein the estimates of measurement errors are stored in at least one measurement error model/map.

15. The method of claim 14, further comprising updating the at least one measurement error model/map with the updated estimates of the measurement errors.

16. The method of claim 14, further comprising updating one or more forward link calibration values of the at least one measurement error model/map based at least in part on measurements associated with one or more location fixes for the mobile station.

17. The method of claim 14, further comprising updating one or more Maximum Antenna Range (MAR) values of the at least one measurement error model/map based at least in part on measurements associated with one or more location fixes for the mobile station.

18. An apparatus comprising:
a receiver to receive, from a mobile station, one or more measurements based at least in part on one or more signals received by the mobile station from one or more signal sources;
one or more processing units programmed with instructions to:
update estimates of measurement errors associated with at least one of the one or more signal sources based, at least in part, on one or more historical measurements associated with the at least one of the one or more signal sources; and
estimate a location of the mobile station based, at least in part, on the one or more measurements and the updated estimates of measurement errors associated with the at least one of the one or more signal sources.

19. The apparatus of claim 18, wherein the one or more processing units are further programmed with instructions to obtain at least one pseudorange measurement to at least one of the signal sources.

20. The apparatus of claim 18, wherein the estimates of measurement errors are obtained over a predetermined time interval.

21. The apparatus of claim 18, wherein the one or more processing units are further programmed with instructions to estimate the location of the mobile station within an asynchronous system.

22. The apparatus of claim 21, wherein the one or more processing units are further programmed with instructions to estimate a timing of the asynchronous system.

23. The apparatus of claim 21, wherein the one or more processing units are further programmed with instructions to estimate a timing uncertainty of the asynchronous system.

24. The apparatus of claim 18, wherein the one or more processing units are further programmed with instructions to estimate the location of the mobile station based, at least in part, on filtering the one or more measurements.

25. The apparatus of claim 24, wherein the filtering provides at least one of bias information or uncertainty/speed.

26. The apparatus of claim 18, wherein the one or more processing units are further programmed with instructions to estimate at least one coverage area associated with the one or more signal sources.

27. The apparatus of claim 18, wherein the one or more processing units are further programmed with instructions to update at least one measurement error model/map with the updated estimates of measurement errors.

28. The apparatus of claim 27, wherein the instructions, in response to being executed by the one or more processing units, further direct the one or more processing units to update one or more forward link calibration values of the at least one measurement error model/map based at least in part on measurements associated with one or more location fixes for the mobile station.

29. The apparatus of claim 27, wherein the instructions, in response to being executed by the one or more processing units, further direct the one or more processing units to update one or more Maximum Antenna Range (MAR) values of the at least one measurement error model/map based at least in part on measurements associated with one or more location fixes for the mobile station.

30. An article comprising: a storage medium comprising machine readable instructions stored thereon executable by one or more processing units to:
obtain one or more measurements, from a mobile station, based at least in part on one or more signals received by the mobile station from one or more signal sources;
update estimates of measurement errors associated with at least one of the one or more signal sources based, at least in part, on one or more historical measurements associated with the at least one of the one or more signal sources; and
estimate a location of the mobile station based, at least in part, on the one or more measurements and the updated estimates of measurement errors associated with the at least one of the one or more signal sources.

31. The article of claim 30, wherein at least one of the plurality of signal sources comprises a satellite vehicle (SV) as part of a Satellite Positioning System (SPS), and at least one of the one or more signal sources comprises one or more terrestrial base stations.

32. The article of claim 30, wherein the instructions are further executable by the one or more processing units to process at least one pseudorange measurement to at least one of the one or more signal sources.

33. The article of claim 32, wherein the instructions are further executable by the one or more processing units to update the estimates of the measurement errors with the at least one pseudorange measurement.

34. The article of claim 30, wherein the estimates of measurement errors comprise measurements obtained over a predetermined time interval.

35. The article of claim 30, wherein the instructions are further executable by the one or more processing units to store the estimates of the measurement errors in at least one measurement error model/map.

36. The article of claim 30, wherein the instructions are further executable by the one or more processing units to estimate the location of the mobile station within an asynchronous system.

37. The article of claim 36, wherein the instructions are further executable by the one or more processing units to estimate a timing of the asynchronous system.

38. The article of claim 36, wherein the instructions are further executable by the one or more processing units to estimate a timing uncertainty of the asynchronous system.

39. The article of claim 30, wherein the instructions are further executable by the one or more processing units to filter the one or more measurements.

40. The article of claim 30, wherein the instructions are further executable by the one or more processing units to estimate at least one coverage area associated with the one or more signal sources.

41. The article of claim 30, wherein the instructions are further executable by the one or more processing units to update at least one measurement error model/map with the updated estimates of the measurement errors.

42. The article of claim 41, wherein the instructions are further executable by the one or more processing units to update one or more forward link calibration values of the at least one measurement error model/map based at least in part on measurements associated with one or more location fixes for the mobile station.

43. The article of claim 41, wherein the instructions are further executable by the one or more processing units to update one or more Maximum Antenna Range (MAR) values of the at least one measurement error model/map based at least in part on measurements associated with one or more location fixes for the mobile station.

44. An apparatus comprising:
means for obtaining one or more measurements from a mobile station, wherein the one or more measurements are based at least in part on one or more signals received by the mobile station from one or more signal sources;
means for updating estimates of measurement errors associated with at least one of the one or more signal sources based, at least in part, on one or more historical measurements associated with the at least one of the one or more signal sources; and
means for estimating a location of the mobile station based, at least in part, on the one or more measurements and updated estimates of the measurement errors.

45. The apparatus of claim 44, wherein at least one of the one or more signal sources comprises a satellite vehicle (SV) as part of a Satellite Positioning System (SPS), and at least one of the one or more signal sources comprises one or more terrestrial base stations.

46. The apparatus of claim 45, wherein the one or more terrestrial base stations comprise a Code Division Multiple Access (CDMA) 2000 system.

47. The apparatus of claim 44, wherein the means for obtaining the one or more measurements is adapted to obtain at least one pseudorange measurement to at least one of the signal sources.

48. The apparatus of claim 47, wherein the means for obtaining the one or more measurements is further adapted to update the estimates of the measurement errors with the at least one pseudorange measurement.

49. The apparatus of claim 44, wherein the one or more historical measurements comprise measurements obtained over a predetermined time interval.

50. The apparatus of claim 44, further comprising a model/map means for storing the one or more historical measurements.

51. The apparatus of claim 44, wherein the means for estimating is capable of estimating the location of the mobile station within an asynchronous system.

52. The apparatus of claim 51, wherein the means for estimating is capable of estimating a timing of the asynchronous system.

53. The apparatus of claim 51, wherein the means for estimating is capable of estimating a timing uncertainty of the asynchronous system.

54. The apparatus of claim 44, further comprising a means for filtering the one or more measurements.

55. The apparatus of claim 54, wherein the means for filtering provides at least one of bias information or uncertainty/speed.

56. The apparatus of claim 44, wherein the means for estimating is capable of estimating at least one coverage area associated with the one or more signal sources.

57. The apparatus of claim 44, wherein the means for estimating is capable of updating at least one measurement error model/map with the updated estimates of measurement errors.

58. The apparatus of claim 57, wherein the means for estimating is capable of updating one or more forward link calibration values of the at least one measurement error model/map based at least in part on measurements associated with one or more location fixes for the mobile station.

59. A method, comprising:
communicating with a serving signal source providing wireless service to a mobile station within a serving sector; and
acquiring one or more calibration error estimates associated with the serving signal source and one or more other signal sources, based at least in part on an identity of the serving signal source.

60. The method of claim 59, further comprising utilizing the one or more calibration error estimates to determine primary ranges from the mobile station to the serving signal source and at least two other signal sources.

61. The method of claim 60, further comprising estimating a location of the mobile station based at least in part on the determined primary ranges.

62. The method of claim 59, further comprising estimating a velocity of the mobile station based at least in part on the calibration error estimates, wherein the calibration error estimates comprise Doppler or delta-range bias or uncertainty information.

63. The method of claim 61, further comprising acquiring one or more location-specific calibration error estimates associated with the estimated location of the mobile station.

64. The method of claim 63, further comprising utilizing the one or more location-specific calibration error estimates to determine one or more secondary ranges from the mobile station to the serving signal source and at least two other signal sources.

65. The method of claim 64, further comprising estimating a location of the mobile station based at least in part on the determined secondary ranges.

66. The method of claim 61, further comprising estimating, from a geographical model, an elevation associated with the estimated location.

67. The method of claim 59, wherein the one or more calibration error estimates are based at least in part on a channel utilized by the serving signal source to provide wireless service to the mobile station.

68. The method of claim 59, further comprising acquiring the one or more calibration error estimates from a base station almanac.

69. A mobile station, comprising:
a receiver to receive wireless service from a serving signal source; and
a processing unit to initiate acquisition of one or more calibration error estimates associated with the serving signal source and one or more other signal sources, based at least in part on an identity of the serving signal source.

70. The mobile station of claim 69, wherein the processing unit is capable of estimating primary ranges from the mobile station to the serving signal source and at least two other signal sources based at least in part on the one or more calibration error estimates.

71. The mobile station of claim 70, wherein the processing unit is capable of estimating a location of the mobile station based at least in part on the determined primary ranges.

72. The mobile station of claim 71, wherein the processing unit is capable of initiating acquisition of one or more location-specific calibration error estimates associated with the determined location of the mobile station.

73. The mobile station of claim 72, wherein the processing unit is capable of estimating secondary ranges from the mobile station to the serving signal source and at least two other signal sources based at least in part on the one or more location-specific calibration error estimates.

74. The mobile station of claim 73, wherein the processing unit is capable of determining a location of the mobile station based at least in part on the determined secondary ranges.

75. The mobile station of claim 71, wherein the processing unit is capable of determining, from a geographical model, an elevation associated with the estimated location.

76. The mobile station of claim 69, wherein the one or more calibration error estimates are based at least in part on a frequency utilized by the serving signal source to provide wireless service to the mobile station.

77. The mobile station of claim 69, wherein the processing unit is capable of estimating a velocity of the mobile station based at least in part on the one or more calibration error estimates, wherein the one or more calibration error estimates comprise Doppler or delta-range bias or uncertainty estimates.

78. An apparatus, comprising:
means for communicating with a serving signal source providing wireless service to a mobile station within a service sector; and
means for acquiring one or more calibration error estimates associated with the serving signal source and one or more other signal sources based at least in part on an identity of the serving signal source.

79. The apparatus of claim 78, further comprising means for utilizing the one or more calibration error estimates to determine primary ranges from the mobile station to the serving signal source and at least two other signal sources.

80. The apparatus of claim 79, further comprising means for estimating a location of the mobile station based at least in part on the determined primary ranges.

81. The apparatus of claim 80, further comprising means for acquiring one or more location-specific calibration error estimates associated with the estimated location of the mobile station.

82. The apparatus of claim 81, further comprising means for utilizing the one or more location-specific calibration error estimates to determine secondary ranges from the mobile station to the serving signal source and at least two other signal sources.

83. The apparatus of claim 82, further comprising means for estimating a location of the mobile station based at least in part on the determined secondary ranges.

84. The apparatus of claim 80, further comprising means for estimating, from a geographical model, an elevation associated with the estimated location.

85. The apparatus of claim 78, further comprising means for acquiring the one or more calibration error estimates from a base station almanac.

86. The apparatus of claim 78, further comprising means for estimating a velocity of the mobile station based at least in part on the one or more calibration error estimates, wherein the one or more calibration error estimates comprise Doppler or delta-range bias or uncertainty estimates.

87. An article comprising: a storage medium having stored thereon instructions executable by a processing unit to:
communicate with a serving signal source providing wireless service to a mobile station within a service sector; and
initiate acquisition of one or more calibration error estimates associated with the serving signal source and one or more other signal sources based at least in part on an identity of the serving signal source.

88. The article of claim 87, wherein the instructions are further executable by the processing unit to utilize the one or more calibration error estimates to determine primary ranges from the mobile station to the serving signal source and at least two other signal sources.

89. The article of claim 88, wherein the instructions are further executable by the processing unit to estimate a location of the mobile station based at least in part on the determined primary ranges.

90. The article of claim 89, wherein the instructions are further executable by the processing unit to initiate acquisition of one or more location-specific calibration error estimates associated with the estimated location of the mobile station.

91. The article of claim 90, wherein the instructions are further executable by the processing unit to utilize the one or more location-specific calibration error estimates to determine secondary ranges from the mobile station to the serving signal source and at least two other signal sources.

92. The article of claim 91, wherein the instructions are further executable by the processing unit to estimate a location of the mobile station based at least in part on the determined secondary ranges.

93. The article of claim 89, wherein the instructions are further executable by the processing unit to estimate, from a geographical model, an elevation associated with the estimated location.

94. The article of claim 87, wherein the one or more calibration error estimates are based at least in part on a channel utilized by the serving signal source to provide wireless service to the mobile station.

95. The article of claim 87, wherein the instructions are further executable by the processing unit to initiate acquisition of the one or more calibration error estimates from a base station almanac.

96. The article of claim 87, wherein the wherein the instructions are further executable by the processing unit to estimate a velocity of the mobile station based at least in part on the one or more calibration error estimates, wherein the one or more calibration error estimates comprise Doppler or delta-range bias or uncertainty estimates.
